(19) United States
(12) Patent Application Publication
(10) Pub. No.: US 2026/0100595 A1
(43) Pub. Date: Apr. 9, 2026

(54) Series-Discharge Parallel-Charge Multi Cell Battery Pack

(71) Applicant: Bradford T. Hite, Valencia, CA (US)

(72) Inventor: Bradford T. Hite, Valencia, CA (US)

(21) Appl. No.: 18/911,016

(22) Filed: Oct. 9, 2024

(51) Int. Cl. H02J 7/00; H01M 10/052; H01M 10/44; H01M 10/46; H01M 50/269

(52) U.S. Cl. CPC H02J 7/575; H01M 10/052; H01M 10/441; H01M 10/46; H01M 50/269; H02J 7/40; H02J 7/61; H02J 7/63; H02J 7/933

(57) ABSTRACT

A unique system for the implementation of a multi cell battery pack whereby the individual cells are organized in different configurations for discharge or charging operation is presented. Battery pack discharge operation utilizes a series (stacked) configuration capable of producing a high output voltage necessary for the application. In contrast, charging operation configures the individual cells into a parallel (single layer) organization offering a simple fast charge operation provided by natural current sharing of the cells. Switch over between the two configurations is achieved using switching array implemented by low-cost N-channel MOSFET devices. Usage of dual modes for battery charge/discharge operation offers a simplified implementation with the highest performance. An application is also described where the present invention is used as a compatible replacement of a standard 12V lead acid automotive battery.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE APPENDICES

Not Applicable

### BACKGROUND OF THE INVENTION

### 1. Field of the Invention

This invention relates to the field of Lithium rechargeable battery packs used for vehicle applications. A charging method is described allowing the full capability of the internal cells to be utilized. Internal cells are configured for discharge in series (stacked) to achieve a higher output operating voltage while a parallel (single level) lower voltage configuration is used for charging. Parallel charging is desirable supporting faster charge rates and removes the need for active cell balancing controls. An application is presented for a compatible replacement of a standard 12V lead acid automotive battery.

### 2. Description of the Related Art

The usage of stacked lithium cells to construct a higher output voltage battery pack has been found in industry for many years. Implementation of these pack configurations require control circuitry providing charging operation and safety during discharge into a load. Large battery packs are utilized in applications such as an electric vehicle whereby the battery pack is capable of producing an output voltage in the range of 500 to 600 volts used for powering drive motor(s). Charging systems for these types of battery packs involves placing a large external DC voltage across the internal cell stack and providing cell balancing methods to achieve a full charge state. Each cell needs to be independently monitored and balanced to produce a full charge due to differences between individual cells within the stack. Cell balancing typically will consist of placing a switched resistive element in parallel with each cell allowing an adjustment of charge current flowing thru each cell. In this manner, all cells in the fully charged stack will obtain full capacity to maximize performance. Incomplete charging of any cell within the stack limits the discharge performance of the entire stack. The present invention implements a different topology whereby during charging the cell stack is reconfigured to have a single layer with all cells effectively operating in parallel. The lithium cells will naturally achieve a full charge due to current distribution across the single parallel layer thereby eliminating the need for cell balancing methods. Conversely during normal discharge operation, the cells are reconfigured in series allowing the production of higher output voltages. Switching between these two configurations is controlled by a switch matrix containing low-cost N-channel MOSFETS acting as either an ideal diode or low side switch.

Several prior art references in this field teach the usage of lithium based battery cells to construct a larger battery pack. Koebler in U.S. Pat. No. 9,412,994 B2 titled “Lithium Starter Battery and Solid State Switch Therefor” describes a battery pack arrangement whereby multiple cells are stacked in series. In addition to the cell stack, a transistor switch is described placed either above or below the cells to provide a safety cutoff disconnect. Koebler's system requires charging of the fixed cell stack to including cell balancing circuitry and safety disconnect transistor switch control. This configuration now is commonly used in the industry for battery pack construction but is dependent on having a sufficiently high external charging voltage to fully charge the cell stack. In a typical 12V automotive battery application, the external charging voltage available to the battery pack will range from 13.7V to 14.7V. Commonly used LiFePO4 chemistry battery cells require an individual applied charging voltage of 3.65V or 14.6V for 4× battery stack and cannot be effectively fully charged in a 12V automotive application resulting in a 20% to 40% reduction in capacity. The present invention correctly charges each cell at the required 3.65V level thereby increasing battery operating life time, significantly decreasing charging time and offering full usage of 100% cell capacity.

Yunhai in CN 101262140A titled “Series-Parallel Switching Charing Method of the Lithium Power Battery Pack and the Cycle Service life of the Charging Device” describes a series cell stack configuration whereby charging of individual cells is achieved in parallel using transformer coupling. In the system of Yanhai, each cell in the stack is coupled to a secondary transformer winding and control circuit to providing a charge current. This implementation would be extremely difficult to mechanically package due to the alignment of multiple transformer windings and associated battery cell. The system of Yunhai is significantly different from the present invention which utilizes a transistor based switch matrix to change the electrical connection between cells from a series configuration to a parallel configuration.

### BRIEF SUMMARY OF THE INVENTION

The present invention comprises a multi cell battery pack whereby the individual cells are organized in different configurations for discharge or charging operation. Discharge operation utilizes a series or stacked configuration capable of producing a high output voltage necessary for the application. In contrast, charging operation configures the individual cells into a single layer parallel organization offering a simple fast charge operation provided by natural current sharing of the cells. Switch over between the two configurations is achieved using switching array implemented by low-cost N-channel MOSFET devices. Usage of dual modes for battery charge/discharge operation offers a simplified implementation with the highest performance.

### BRIEF DESCRIPTION OF THE DRAWINGS

FIG. 1 is a system block diagram for the present invention.

FIG. 2 is a block diagram showing a simplified parallel charge operation configuration.

FIG. 3 is a block diagram showing a simplified series discharge operation configuration.

FIG. 4 is an example schematic diagram detailing a four-switch low charge rate implementation of the present invention.

FIG. 5 is an example schematic diagram detailing a four-switch high charge rate implementation of the present invention.

FIG. 6 is an example schematic diagram detailing a two-switch implementation of the present invention.

### REFERENCE NUMERALS IN THE DRAWINGS

| | | | |
|---|---|---|---|
| 100A | Cell High Side | 102A | Battery Cell or |
| 100B | Discharge Switch | 102B | Cell Array |
| 100C | | 102C | |
| 100D | | 102D | |
| 104A | Cell Low Side | 106A | Charge Current |
| 104B | Charge Switch | 106B | Steering Diode |
| 104C | | 106C | |
| | | 106D | |
| 108 | Charger Control | 110 | Cell Pack Positive |
| | Circuit | | Voltage Terminal |
| 112 | Cell Pack Negative | 114 | Control Circuit |
| | Voltage Terminal | | |
| 200 | Cell Pack Positive | 202 | Battery Cell or |
| | Voltage Terminal | | Cell Array |
| 204 | Battery Cell or | 206 | Battery Cell or |
| | Cell Array | | Cell Array |
| 208 | Battery Cell or | 210 | Cell Pack Negative |
| | Cell Array | | Voltage Terminal |
| 212 | Charger Control | 214 | Charge Current |
| | Circuit | | Steering Diode |
| 216 | Charge Current | 218 | Charge Current |
| | Steering Diode | | Steering Diode |
| 220 | Charge Current | 222 | Matched Diode Array |
| | Steering Diode | | |
| 300 | Charger Control | 302 | Battery Cell or |
| | Circuit | | Cell Array |
| 304 | Battery Cell or | 306 | Battery Cell or |
| | Cell Array | | Cell Array |
| 308 | Battery Cell or | 310 | Battery Pack Positive |
| | Cell Array | | Voltage Terminal |
| 312 | Battery Pack | 314 | Matched Diode Array |
| | Negative | | |
| | Voltage | | |
| | Terminal | | |
| 316 | Charge Current | 318 | Charge Current |
| | Steering Diode | | Steering Diode |
| 320 | Charge Current | 322 | Charge Current |
| | Steering Diode | | Steering Diode |

### DETAILED DESCRIPTION OF THE INVENTION

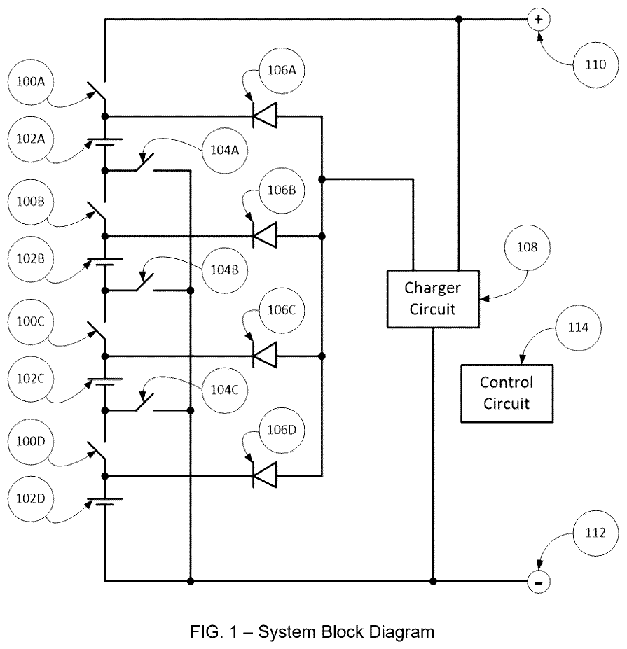

The preferred embodiment system block diagram of the present invention is shown in FIG. 1 as a multi cell battery pack configured with a switch matrix providing a series or parallel connection topologies. This preferred embodiment shows a configuration having four stacked cell(s) or cell array(s). Other embodiments can support more or less stacked cell elements needed to achieve the desired overall cell pack output voltage. In this preferred embodiment, the switch matrix containing switches 100 (A to D) and 104 (A to C) can be configured to provide either a series (stacked) cell or parallel (single level) cell organization based on operating in charge or discharge mode. Cell high side discharge switches 100A, 100B, 100C and 100D provide a closed connection during discharge and an open connection for charging. These switches effectively disconnect each battery cell positive terminal depending on the operational mode. The implementation of switch elements 100A, 100B, 100C and 100D can use but is not limited to back-back N-Channel MOSFET(s). Battery cell(s) or cell array(s) 102A, 102B, 102C and 102D implement charge storage in the battery pack. A cell array consists of multiple cells directly wired in parallel thereby providing an increased charge storage capacity versus a single cell. Cell low side charge switches 104A, 104B, 104C provide an open connection during discharge and a closed connection for charging. These switches effectively disconnect each battery cell negative terminal depending on operational mode. The implementation of switch elements 104A, 104B, 104C and 104D can use but is not limited to a N-Channel MOSFET. Charge current steering diodes 106A, 106B, 106C and 106D provide isolation between charging circuit 108 and each individual battery cell or cell array 102. These diodes can optionally be replaced by a transistor switch with increased complexity of the associated control circuitry. Charger Control Circuit 108 serves to reduce an external charging voltage present on battery pack terminals 110 and 112 for application to each cell or cell array. Typically, the external charging voltage could be supplied by a vehicle's alternator or generator while the engine is running. Battery charging control circuit 108 is disabled during discharge operation and active for charging. Control of charge/discharge operation and optional safety monitoring is provided by control circuit 114. Selection between charge and discharge operation can be implemented by control circuit 114 using several methods but not limited to: 1) Detection of an external charging voltage, 2) Control by an external discrete input signal from the vehicle, or 3) Control by a software message received via CAN bus from the vehicle.

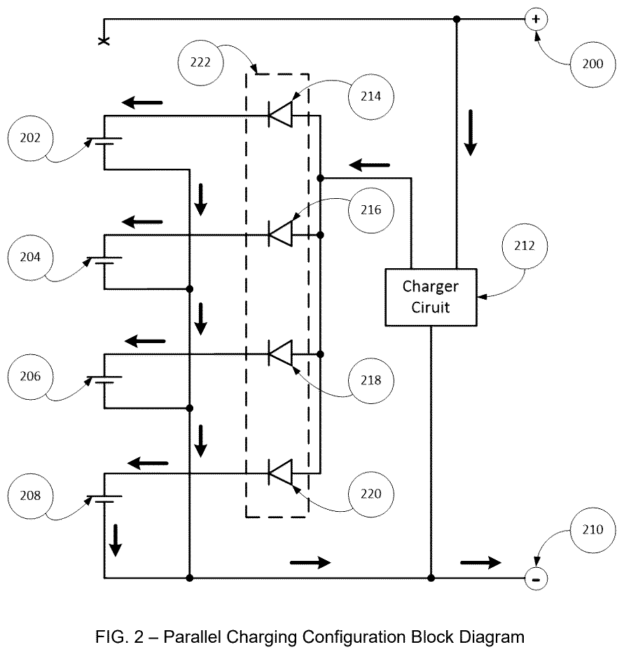

FIG. 2 shows a simplified block diagram of the preferred embodiment configured for cell pack charging operation. Charging operation is enabled by opening of switch group 100, closing of switch group 104 and enabling charger circuit 212. Balancing of charging voltages across cell or cell arrays 202, 204, 206 and 208 is supported by using matched steering diodes 214, 216, 218 and 220. In this manner, the charger circuit 212 only would need to monitor voltage on one of the cell(s) or cell array(s) to achieve effective charging. During charge operation, an external charging voltage is applied across battery pack terminals 200 and 210. This voltage is current/voltage controlled by charger circuit 212 to providing charging current thru steering diodes 214, 216, 218 and 220. Charging current flows into the positive terminals of cell(s) or cell array(s) 202, 204, 206 and 208. Finally, charging current returns to the negative cell pack terminal 210. Charge operation completes by charger circuit 212 shutting down the current/voltage charge cycle. Charge current flow direction is indicated by the heavy arrows.

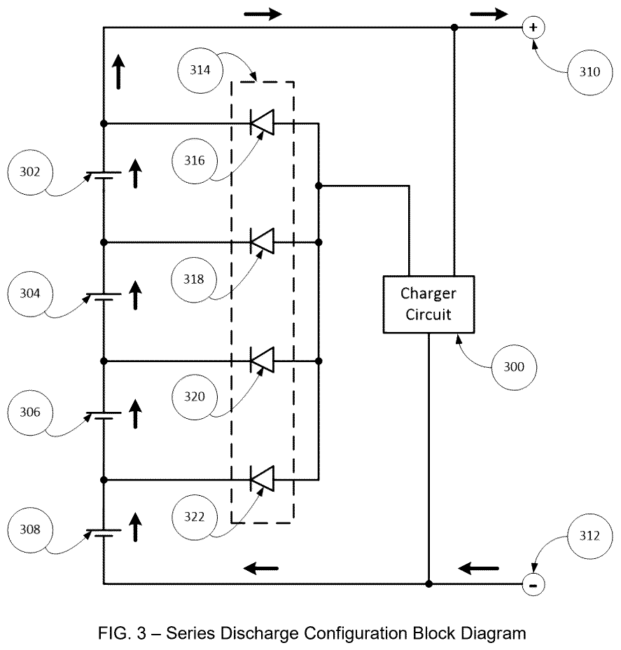

FIG. 3 shows a simplified block diagram of the preferred embodiment configured for cell pack discharge operation. Discharge operation is enabled by closing of switch group 100, opening of switch group 104 and disabling charger circuit 300. Blocking of discharge current flow from cell or cell arrays 302, 304, 306 and 308 into charging circuit 300 is provided by diodes 316, 318, 320 and 322. In this configuration, an external voltage will now appears across battery pack terminals 310 and 312. During discharge, current flows out from the positive terminal of cell(s) as supplied by the stacked configuration of cell(s) or cell array(s) 202, 204, 206 and 208. Cell stacking is a common method used to achieve a higher operating output voltage for the cell pack. Discharge current flow direction is indicated by the heavy arrows.

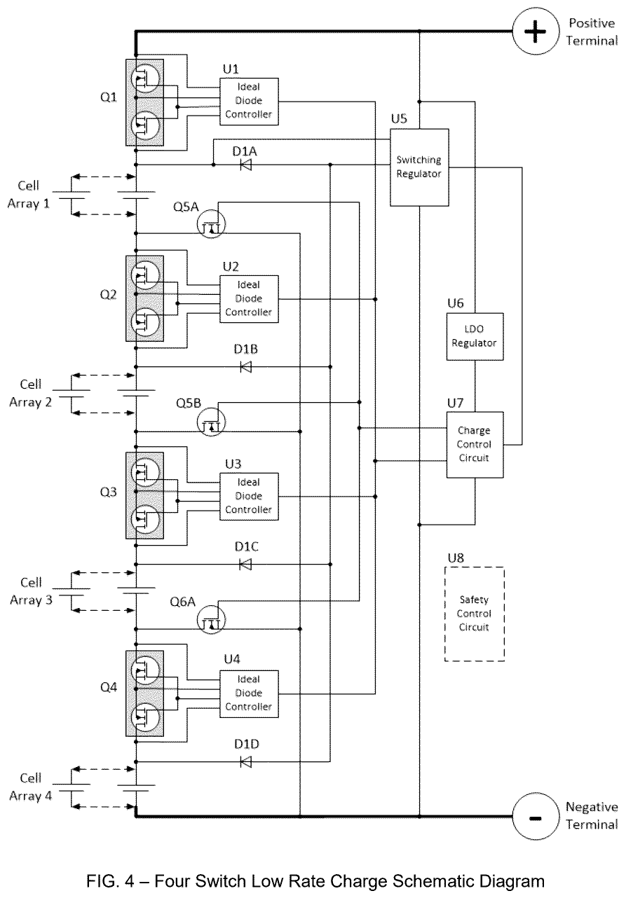

An example electrical implementation of the preferred embodiment is shown in the FIG. 4 schematic diagram. Cell arrays 1, 2, 3 and 4 are shown containing multiple cells necessary to achieve the desired overall discharge current capacity for the cell pack. Also, this example configuration is based on usage of matched steering diodes with a single charging voltage monitor point at cell array 1. The electrical elements shown in FIG. 4 will now be described with reference to system block diagram FIG. 1. Switch 100A consists of dual MOSFET Q1 with ideal diode controller U1, switch 100B consists of dual MOSFET Q2 with ideal diode controller U2, switch 100C consists of dual MOSFET Q3 with ideal diode controller U3 and switch 100D consists of dual MOSFET Q4 with ideal diode controller U4. Typical example electrical components to implement this switch circuit are Goford G130N06S2 Dual MOSFET (Q1, Q2, Q3, Q4) and Onsemi NCV68261 Ideal Diode and High Side Switch Controller (U1, U2, U3, U4). In the event a higher discharge rate is desired the Goford Dual MOSFET could be replaced with two single MOSFET devices such as Onsemi NTMFS0D5N04XLT1G. Switch 104A consists of MOSFET Q5A, Switch 104B consists of Q5B and Switch 104C consists of Q6A. Typical example electrical components to implement this switch circuit are again the Goford G130N06S2 Dual MOSFET (Q5A, Q5B, Q6B). Steering diodes 106A, 106B, 106C and 106D consist of individual matched diodes within array package D1 as D1A, D1B, D1C and D1D respectively. A typical example electrical component to implement this steering diode array is Texas Instruments UC1611 Quad Schottky Diode Array. Charger circuit 108 consists of Switching Regulator U5 having an adjustable current limit. A typical example electrical component to implement this charger circuit is Vishay SiC437 MicroBUCK DC/DC Converter. Additional circuits shown in FIG. 4 as LDO Regulator U6 and Charge Control Circuit U7 are available from multiple source. An example implementation for the charge control circuit U7 and safety circuit U8 could be an 8-bit microcontroller running a stored program from Microchip.

Battery cell(s) or cell array(s) 102A, 102B, 102C and 102D can consist of most Lithium Ion battery types with LiFePO4 chemistry desired for safety. These cells provide the electrical energy storage within the battery pack. Cells are typically selected by capacity and size in order to support discharge current level and duration. Cell discharge rates (3C to 6C) and charging rates (1C to 3C) are highly variable over temperature must be maintained with safe limits. Individual cells can be connected directly in parallel to create a cell array to further increase current capacity. Typical example LiFePO4 cells of varying capacity to implement cell(s) or cell array(s) 102 can include but are not limited to: 1) Gotion 3.2V 30 Ah LiFePO4 Prismatic Battery Cell 145×100×21 (mm), 2) Fortune LiFePO4 Battery 3.2V 50 Ah Prismatic Cell 170×130×36 (mm) and 3) HighStar LiFePO4 3.2V 100 Ah Prismatic Battery Cell 213×130×40 (mm).

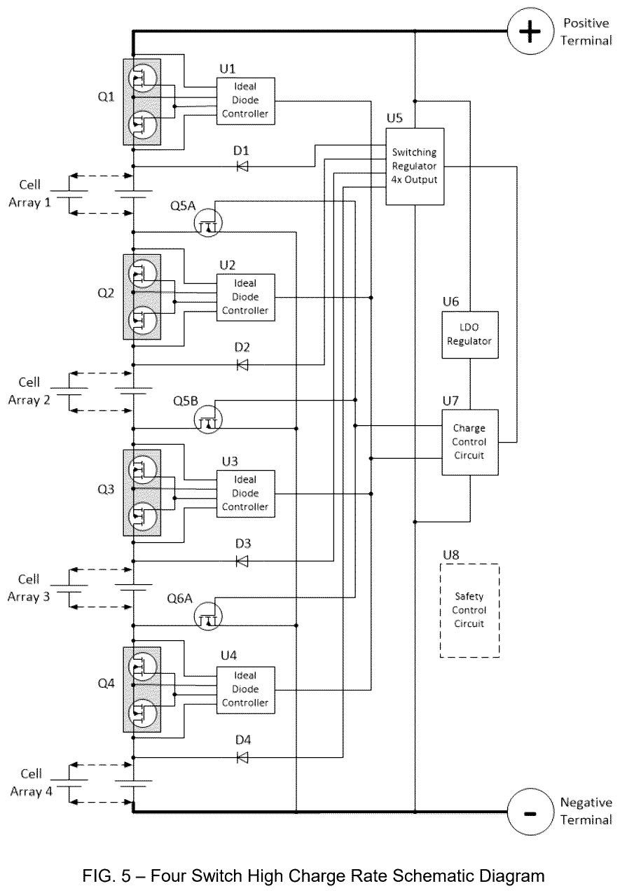

Another example electrical implementation of the preferred embodiment is shown in the FIG. 5 schematic diagram. In this example the matched steering diodes with single output charging circuit is replaced by a four output charging circuit eliminating the matched diode requirement. Another benefit of this topology is increased charging current capability thereby reducing charging time. The four remote voltage monitoring points associated with each of the charging circuit outputs are applied separately to each cell or cell array.

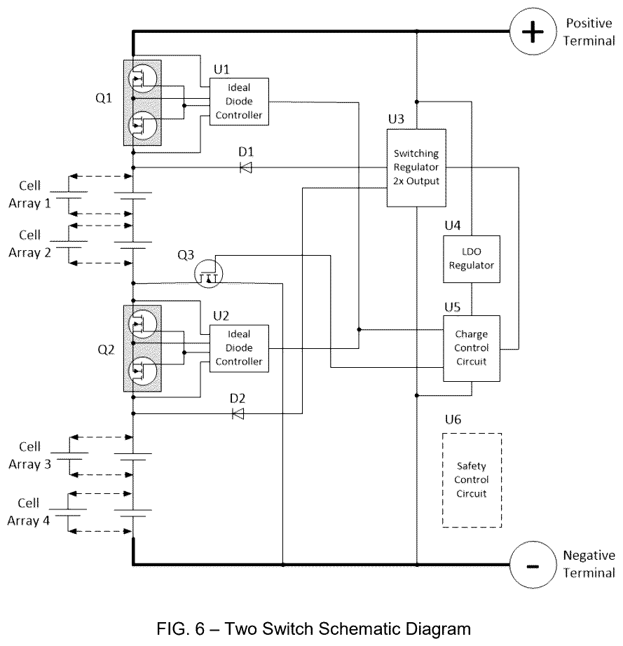

FIG. 6 schematic diagram shows an additional example electrical implementation of the preferred embodiment having a reduced complexity switch matrix. In this example, two cell(s) or cell array(s) are stacked between switch elements in order to reduce resistive discharge current losses. Stacking of two cells without resorting to charge balancing is an accepted practice within the art, however some loss of full charge capacity will be seen. This example trades off degraded full charge capacity in order to minimize electrical component count.

An example of the present invention used to implement a starting battery for a 12V automotive application is now be described. Given the usage of LiFePO4 50 Ah cells, the required cell charging voltage is 3.65V and normal operating voltage range is 3.2V to 2.5V. Further, maximum rates for cell continuous discharge, pulse discharge and charge operation are 3C (150A), 6C (300A) and 1C (50A) respectively. Design goals for the battery pack are: 1) cold cranking amps of 200A, 2) capacity 40 Ahr and charging amps of 50A and 3) charge time of 10 hours from 50% capacity. Based on the cell parameters, the implementation will require four single stacked cell(s) (not an array of cells) arranged as shown in FIG. 4. Charging of the battery to full capacity will take 2.5A per cell over 10 hours. The current rating for the UC3611 diode array from FIG. 4 is 3A. The charging circuit will need to produce a total of 10A across the 4 cells; the maximum output rating for the SiC437 is 12A. Given design parameters, the circuit shown in FIG. 4 provides an adequate implementation. In the event a shorter charging interval is required, the circuit topology of FIG. 5 can be implemented.

The claimed invention is:

1. A battery pack having a positive terminal and a negative terminal comprising:
a. at least two or more lithium-based rechargeable cells or cell arrays coupled to a switch matrix, the group of lithium-based rechargeable cells or cell arrays storing electrical energy;
b. a charger circuit coupled to the switch matrix and the battery pack terminals, the charger circuit generating a charging current;
c. a control circuit coupled to the switch matrix, the control circuit selecting the switch matrix configuration for charge or discharge operation;
d. wherein the switch matrix can be configured to connect the lithium-based rechargeable cells or cell arrays in a parallel connection during charge operation; and
e. wherein the switch matrix can be configured to connect the lithium-based rechargeable cells or cell arrays in a series connection during discharge operation.

2. The system of claim 1, wherein a safety monitoring circuit can isolate the positive terminal for unsafe conditions of over-charge or over-discharge.

3. The system of claim 1, wherein the control circuit selection between charge and discharge operation is based on detection of an external charge voltage.

4. The system of claim 1, wherein the control circuit selection between charge and discharge operation is based on an external discrete input signal.

5. The system of claim 1, wherein the control circuit selection between charge and discharge operation is based on reception of a software message via CAN bus.

6. A method of configuring cells or cell arrays within a battery pack comprising:
a. storing electrical energy in at least two or more lithium-based rechargeable cells or cell arrays;
b. generating switch matrix control information by a control circuit;
c. selecting battery pack charge or discharge operation by a switch matrix in response to switch matrix control information;
d. configuring the lithium-based rechargeable cells or cell arrays in a series connection during battery pack discharge operation;
e. configuring the group of lithium-based rechargeable cells or cell arrays in a parallel connection during battery pack charge operation; and
f. generating a charging current by a charging circuit during battery pack charge operation.

7. The method of claim 6, further comprising of monitoring charge and discharge operation by a safety circuit to isolate the positive terminal for unsafe conditions of over-charge and over-discharge.

8. The method of claim 6, further comprising of selecting between charge and discharge operation by a control circuit based on detection of an external charge voltage.

9. The method of claim 6, further comprising of selecting between charge and discharge operation by a control circuit based on an external discrete input signal.

10. The system of claim 6, further comprising of selecting between charge and discharge operation by a control circuit based on reception of a software message via CAN bus.
